(19) United States
(12) Patent Application Publication
(10) Pub. No.: US 2004/0091106 A1
(43) Pub. Date: May 13, 2004

(54) Scrambling of data streams having arbitrary data path widths

(76) Inventors: Frank H. Moore, Durham, NC (US); Kevin M. Traynor, Cary, NC (US)

Correspondence Address: Burns, Doane, Swecker & Mathis, L.L.P., P.O. Box 1404, Alexandria, VA, 22313-1404, US

(21) Appl. No.: 10/289,999

(22) Filed: Nov. 7, 2002

(51) Int. Cl. H04K 1/04

(52) U.S. Cl. 380/37

(57) ABSTRACT

An arrangement is described for scrambling data streams having arbitrary data path widths. The arrangement includes logic configured to generate a maximal length pseudorandom sequence of digital signals. A first register is configured to store the pseudorandom sequence. Logic, coupled to the first register, is configured to combine a portion of the pseudorandom sequence with a corresponding portion of an input data stream to produce a scrambled data word. A second register is configured to store the scrambled data word. Circuitry is configured to circularly shift the pseudorandom sequence a number of bits forming the portion of the pseudorandom sequence used to produce the scrambled data word.

### BACKGROUND

What is described are arrangements for scrambling data streams. In particular, arrangements for providing scrambling of data streams having arbitrary data path widths are presented.

Data scramblers are commonly used in digital transmission systems to convert digital signals (i.e., “ones” [1s] or “zeros” [0s]) into a pseudorandom noise (PN) sequence that is free from long strings of simple patterns, such as patterns of all 1s or 0s. The data scrambler facilitates timing extraction, reduces the accumulation of jitter, and prevents baseline drift in the transmitted digital signal.

One method of generating the PN sequence needed to scramble a digital data stream is through the use of linear feedback shift registers (LFSRs). LFSRs sequence through 2^{N}−1 states, where N is the number of memory elements (e.g., flip-flops) in the LFSR. At each clock edge (rising or falling), the contents of the flip-flops are shifted right by one position. There is a feedback path from predefined flip-flops to the leftmost flip-flop through an exclusive-NOR (XNOR) or an exclusive-OR (XOR) gate. A value of all 1s is illegal in the case of an XNOR feedback, and a value of all 0s is illegal for XOR feedback. The illegal state causes the counter to remain in its present state, locking out any further new values from being generated by the LFSR.

LFSRs have several variables used to characterize their operation. These variables include: the number of stages in the shift register; the number of taps in the feedback path; the position of each tap in the shift register stage; and the initial starting condition of the shift register, often referred to as the “fill” state. The shift register length is often referred to as the degree, and the longer the shift register, the longer the duration of the PN sequence before it repeats. For a shift register of fixed length N, the number and duration of the sequences it can generate are determined by the number and position of taps used to generate the parity feedback bit.

The combination of taps and their location in an LFSR is often described using a characteristic or generating polynomial. Various conventions are used to map the terms of the characteristic polynomial to the corresponding register stages in an LFSR. According to one exemplary convention, the outputs of each of the registers in the shift register is represented by a term in the characteristic polynomial having a raised-power equal to the corresponding bit number of the register. The terms representing registers having outputs that contribute to the LFSR feedback path have a coefficient of “1”, while those terms representing registers having outputs that do not contribute to the LFSR feedback path have a coefficient of “0”. The trailing “1” in the polynomial represents the raised-power term X⁰, and corresponds to the output of the last stage of the LFSR's shift register.

Whether denoted as X⁰ or not, the last tap of the shift register is always used in the shift register feedback path. In contrast, the highest order term of the polynomial is the signal connecting the XOR (or XNOR) output to the shift register input, but does not feed back into the XOR parity calculation along with the other taps identified in the polynomial. Consequently, the highest order term is never identified in the polynomial. Applying this mapping convention to the exemplary N-bit LFSR shown in FIG. 1 yields the characteristic polynomial: P(X)=X²+X+1.

LFSR generators produce what are called linear recursive sequences (LRS) because all operations are linear. Generally speaking, the length of the sequence before repetition occurs depends upon two things, the feedback taps and the initial or fill state. An LFSR of any given size m (number of registers) is capable of producing every possible state during the period T=2^{m}−1, but will do so only if proper feedback taps, or terms, have been chosen. Such a sequence is called a maximal length sequence, maximal sequence, or less commonly, maximum length sequence. Maximal length generators can actually produce two sequences. One is the trivial one, of length one, that occurs when the initial state of the generator is all zeros. The other one, the useful one, has a length of 2^{m}−1. Together, these two sequences account for all 2^{m} states of an m-bit state register. Tables have been developed describing the feedback configurations and fill states for various degree LFSRs to produce maximal length PN sequences.

The PN code produced by the LFSR generator is combined with a digital data stream, (e.g., using an XOR block as shown in FIG. 1), to produce a scrambled data stream. Conventionally, the PN code is combined with the digital data stream at the LFSR's clock speed (denoted as “X” in FIG. 1), which corresponds to the data rate of the input data stream. As data rates in today's digital communication systems continue to increase, the task of combining generated PN codes with the data stream “at speed” becomes commensurately challenging, and requires increasing amounts of power to produced the scrambled data stream.

### SUMMARY

Accordingly, one object is to provide techniques that perform high data rate scrambling at lower clock speeds. This and other objects are addressed through arrangements for providing scrambling of data streams having arbitrary data path widths.

According to a first exemplary embodiment, an arrangement is described for scrambling data streams having arbitrary data path widths. The arrangement includes logic configured to generate a maximal length pseudorandom sequence of digital signals. A first register is configured to store the pseudorandom sequence. Logic, coupled to the first register, is configured to combine a portion of the pseudorandom sequence with a corresponding portion of an input data stream to produce a scrambled data word. A second register is configured to store the scrambled data word. Circuitry is configured to circularly shift the pseudorandom sequence a number of bits forming the portion of the pseudorandom sequence used to produce the scrambled data word.

According to a second exemplary embodiment, an arrangement is described for scrambling data streams having arbitrary data path widths. The arraignment includes logic configured to generate a maximal length pseudorandom sequence of digital signals. Memory is configured to store a series of equal-sized portions of the pseudorandom sequence, the number of portions being equal to a number of bits forming the entire pseudorandom sequence, each portion being shifted by one bit, either left or right, with respect to an adjacent portion in the series. Logic is configured to select a portion of the pseudorandom sequence stored in the memory. Logic, coupled to the memory, is configured to combine the selected portion of the pseudorandom sequence with a corresponding portion of an input data stream to produce a scrambled data word. A second register is configured to store the scrambled data word.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

### BRIEF DESCRIPTION OF THE DRAWINGS

The above objects, features, and advantages will become more apparent in light of the following detailed description in conjunction with the drawings, in which like reference numerals identify similar or identical elements, and in which:

FIG. 1 depicts an LFSR that performs “at speed” scrambling of an input data stream;

FIG. 2 depicts exemplary circuitry that provides equivalent data throughput to the scrambler of FIG. 1, but at a lower clock speed; and

FIG. 3 depicts an alternate embodiment to the embodiment shown in FIG. 2.

### DETAILED DESCRIPTION

Preferred embodiments are described below with reference to the accompanying drawings. In the following description, well-known functions and/or constructions are not described in detail to avoid obscuring the description in unnecessary detail.

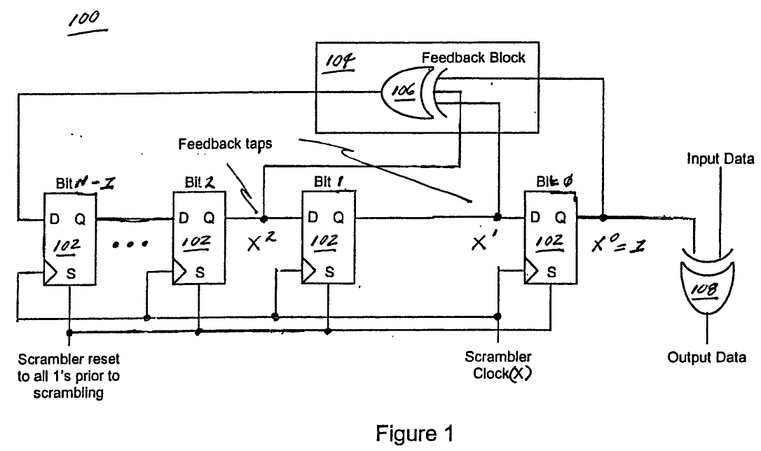

FIG. 1 depicts an exemplary N-bit LFSR-based data scrambler 100. The scrambler 100 includes a shift register having N D-type flip-flops or registers 102 representing each of the bits 0 through N-1 of the shift register. Each of the registers 102 is triggered using a common clock signal X, and may be reset using a common reset signal. Resetting the registers causes the scrambler to produce an output of all 1s. The outputs of the registers (or feedback taps) corresponding to bits 0-2 are coupled to the feedback block 104. Recall from above that this configuration can be represented using the characteristic polynomial P(X)=X²+X+1.

The feedback block 104 includes an XOR gate 106 that performs an exclusive OR'ing operation on the feedback taps. The XOR gate 106 produces a parity signal that is coupled to the input of the first register 102 in the shift register. The output of the scrambler 100 (at the output of the last register in the shift register) is fed to second XOR gate 108. The second XOR gate 108 combines the scrambler output with the input data stream to produce a scrambled output data stream. As described above, the input data is combined with the scrambler output at the clock speed X of the scrambler.

Recall from above that if certain feedback taps are chosen to be coupled to the feedback block 104, the scrambler can be made to produce a maximal length sequence (or MLS). Also recall that the useful MLS for an N-bit LFSR has a length of L=2^{N}−1 before repeating. With these concepts in mind, consider the exemplary case in which the generalized LFSR scrambler 100 of FIG. 1 has N=7 bits, and that the scrambler 100 is configured so as to produce a maximal length PN sequence (the scrambler 100 shown in the figure is not configured as such). From above, the length of the MLS will be L=2⁷−1, or 127 bits, before the sequences repeats. This MLS may be stored, and then later used to generate a scrambled data stream at a reduced scrambler clock speed.

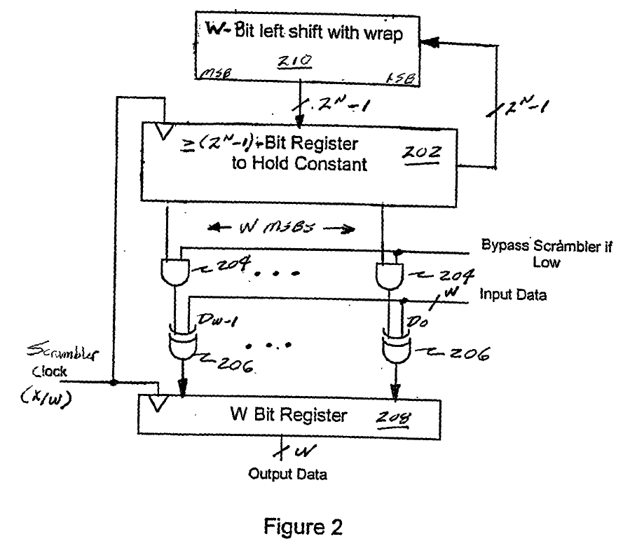

Such an arrangement for generating a scrambled data stream is depicted in FIG. 2. The arrangement includes a first register 202 to store the MLS generated by the scrambler 100. Continuing with example introduced above, the size of register 202 must be at least 2⁷−1, or 127 bits, wide to store the generated sequence. The MLS can be loaded into the first register 202, e.g., when frame transitions occur in the data stream or when a system reset occurs. When the number of bits in the register 202 exceeds the length of the MLS, a beginning portion of the MLS can be stored in the additional bits of the register 202.

Once the MLS is loaded into the first register 202, a portion of the sequence can be combined with a corresponding portion of the data stream to produce a scrambled data word. According to an exemplary embodiment, a number W of the most significant bits (MSBs) of the MLS are combined with W bits of the input data stream D₀ through D_{W-1}, to produce the scrambled data word. The W bits of the input data stream can be combined with the W MSBs of the MLS using XOR gates 206. The W bits of the input data stream can be stored in another register (not shown) prior to being combined in the XOR gates 206 with the MLS portion. The output terminals of the XOR gates 206 can then be fed to a W-bit wide second register 208 that temporarily holds the scrambled data word until released onto a W-bit wide output data bus.

For values of the W greater than 1, both the first and second registers 202, 208 (as well as the input data register not shown) can be clocked at a reduced speed over the scrambler 100 depicted in FIG. 1. The amount of clock speed reduction is determined by the number W of MSBs of the MLS chosen to be combined with the corresponding portion of the data stream, and is equal to the reciprocal of W (or 1/W). Assuming a data rate of X (the speed at which the scrambler 100 of FIG. 1 operates), the registers 202, 208 can be clocked at a reduced speed of X/W and still provide the equivalent scrambled data throughput as the scrambler 100 shown in FIG. 1. When W is chosen to be less than the length of the MLS, circuitry is provided to update the portion of the register 202 that will hold a next W MSBs of the MLS to be combined with a corresponding next portion of the data stream D_{W} through D_{2W-1}.

The arrangement includes circuitry 210 for performing a W-bit circular shift of the contents of the first register 202. For example, the circuitry 210 can perform a W-bit left-shift operation the contents of the first register 202, wrapping the contents shifted out of the register 202 back into the W least significant bits (LSBs) of the register 202. It will be understood that if one were to instead combine W LSBs of the register 202 with the input data stream to produce the scrambled data word, then the circuitry 210 could perform a W-bit right-shift operation, wrapping the contents shifted out of the register 202 back into the W MSBs of the register 202. The circuitry 210 can include a wiring block, configured to perform the appropriate circular shift, multiplexors, combinational logic, or perhaps a shift register, although including an additional shift register in the data stream would add an additional clock cycle to the scrambling process.

The W-bit circularly-shifted MLS produced by the circuitry 210 is loaded into the first register 202 on a transition of the reduced speed scrambler clock at substantially the same time that a prior generated W-bit wide scrambled data word is transferred onto the output bus from the second register 208. By substantially, Applicant means that the transition occurs with the typical setup and hold times, and considering the typical propagation delays, present in conventional clock system designs. The process of combining the W MSBs of the MLS with a corresponding portion of the input data stream to produce a corresponding scrambled data word, and then shifting the MLS MSBs and combining with a next portion of the data stream, can be repeated to produce the desired scrambled data stream using the entire MLS.

Circuitry may also be provided to bypass the scrambler operation under certain operating conditions. According to another exemplary embodiment, W AND logic gates 204 are provided in the signal paths between the first register 202 and the W XOR gates 206. One input of each of the AND gates 204 is tied to one of the W MSB outputs of the first register 202. The second input of each of the AND gates 206 is tied to a common bypass control signal. The output of each of the AND gates 206 is tied the scrambler code input of a respective XOR gate 206. With this exemplary arrangement, when the bypass control signal is set to a logical “0” level, the output of the AND gates 204 will each be at a logical “0” level. This will allow the input data to pass through the XOR gates 206 into the second register 208 unscrambled.

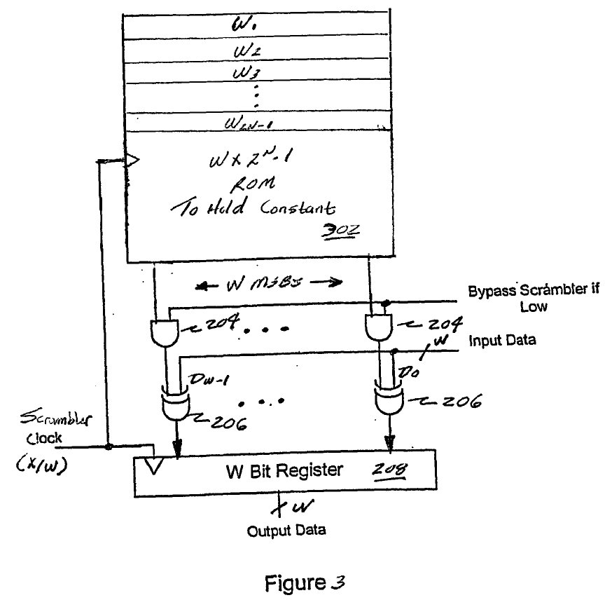

FIG. 3 depicts an alternative embodiment to the arrangement shown in FIG. 2. In this alternative arrangement, the functions of the first register 202 and circuitry 210 are replaced by an addressable memory. The addressable memory can be a read-only memory (ROM) 302, as shown in FIG. 3, random-access memory (RAM), or other type of suitable computer memory. The remaining blocks shown in the alternative arrangement function in the same manner as described above in conjunction with their counterparts shown in FIG. 2.

As shown in FIG. 3, the MLS is stored in the ROM 302. The MLS can alternatively be stored in RAM, in which case, the RAM can be loaded with the MLS when frame transitions occur in the data stream or when a system reset occurs. The MLS is stored in the ROM 302 as 2^{N}−1, W-bit words. Each stored MLS word represents a W-bit wide portion of the entire MLS shifted by one bit, either left or right, with respect to an MLS word stored in an address either before or after the address of the particular stored MLS word. Since the length of the MLS is odd, and thus cannot be an even multiple of W, 2^{N}−1, single-bit-shifted W-bit words are needed to ensure that the appropriately shifted W-bit word is available in the ROM 302 so as to be able to repeatedly cycle though the entire MLS when generating the scrambled data stream.

The appropriately shifted W-bit MLS word is selected to be combined with a corresponding portion of the input data stream on a transition of the reduced speed scrambler clock at substantially the same time that a prior generated W-bit wide scrambled data word is transferred onto the output bus from the second register 208. Circuitry can be included in the addressable ROM 302 (or can be added separately) to select the appropriately shifted W-bit MLS word. For example, a state-machine can be included to select an address within the ROM 302 where to retrieve the appropriately shifted W-bit MLS word based on the length of the MLS and the value of W.

Various aspects have been described in connection with a number of exemplary embodiments. To facilitate an understanding of these embodiments, many aspects were described in terms of sequences of actions that may be performed by elements of a computer system. For example, it will be recognized that in each of the embodiments, the various actions could be performed by specialized circuits or circuitry (e.g., discrete logic gates interconnected to perform a specialized function), by program instructions being executed by one or more processors, or by a combination of both. Moreover, the exemplary embodiments can be considered part of any form of computer readable storage medium having stored therein an appropriate set of computer instructions that would cause a processor to carry out the techniques described herein.

Thus, the various aspects may be embodied in many different forms, and all such forms are contemplated to be within the scope of what has been described. For each of the various aspects, any such form of embodiment may be referred to herein as “logic configured to” perform a described action, or alternatively as “logic that” performs a described action.

Although various exemplary embodiments have been described, it will be understood by those of ordinary skill in this art that these embodiments are merely illustrative and that many other embodiments are possible. The intended scope of the invention is defined by the following claims rather than the preceding description, and all variations that fall within the scope of the claims are intended to be embraced therein.

What is claimed is:

1. An arrangement for scrambling data streams having arbitrary data path widths, comprising:
logic configured to generate a maximal length pseudorandom sequence of digital signals;
a first register configured to store the pseudorandom sequence;
logic, coupled to the first register, configured to combine a portion of the pseudorandom sequence with a corresponding portion of an input data stream to produce a scrambled data word;
a second register configured to store the scrambled data word; and
circuitry configured to circularly shift the pseudorandom sequence a number of bits forming the portion of the pseudorandom sequence used to produce the scrambled data word.

2. The arrangement of claim 1, wherein the logic configured to generate a maximal length pseudorandom sequence of digital signals includes a linear feedback shift register.

3. The arrangement of claim 1, wherein the logic configured to combine a portion of the pseudorandom sequence with a corresponding portion of an input data stream includes a number of exclusive-OR logic gates, each exclusive-OR logic gate having:
a first input coupled to the first register for receiving a bit of the portion of the pseudorandom sequence stored in the first register;
a second input for receiving a bit of the corresponding portion of an input data stream; and
an output coupled to the second register.

4. The arrangement of claim 1, wherein the number of bits forming the portion of the pseudorandom sequence used to produce the scrambled data word is greater than one and is less than a number of bits included in the first register.

5. The arrangement of claim 1, wherein the portion of the pseudorandom sequence used to produce the scrambled data word corresponds to one of a number of most significant bits and a number of least significant bits of the pseudorandom sequence stored in the first register.

6. The arrangement of claim 5, wherein the circuitry configured to circularly shift the copy of the pseudorandom sequence includes:
circuitry configured to shift the contents of the first register by a number of bits equal to the number of bits forming the portion of the pseudorandom sequence used to produce the scrambled data word; and
circuitry configured to wrap the contents shifted out of one end of the first register into the other end of the first register.

7. The arrangement of claim 1, wherein the first and second registers are configured to receive a clock signal operating at a rate equal to a data rate of the input data stream divided by the number of bits forming the portion of the pseudorandom sequence used to produce the scrambled data word.

8. The arrangement of claim 7, wherein the circularly shifted pseudorandom sequence is loaded into the first register on a transition of the clock signal at substantially a same time that the scrambled data word is transferred out of the second register.

9. The arrangement of claim 1, comprising:
logic configured to bypass the combining of a portion of the pseudorandom sequence with a corresponding portion of an input data stream.

10. The arrangement of claim 9, wherein the logic configured to bypass the combining of a portion of the pseudorandom sequence with a corresponding portion of an input data stream includes a number of AND logic gates, each AND logic gate having:
a first input coupled to the first register for receiving a bit of the portion of the pseudorandom sequence stored in the first register;
a second input for receiving a common bypass control signal; and
an output coupled to the logic configured to combine a portion of the pseudorandom sequence with a corresponding portion of an input data stream.

11. The arrangement of a claim 1, comprising:
a third register configured to store the corresponding portion of the input data stream used to produce the scrambled data word.

12. An arrangement for scrambling data streams having arbitrary data path widths, comprising:
logic configured to generate a maximal length pseudorandom sequence of digital signals;
memory configured to store a series of equal-sized portions of the pseudorandom sequence, the number of portions being equal to a number of bits forming the entire pseudorandom sequence, each portion being shifted by one bit, either left or right, with respect to an adjacent portion in the series;
logic configured to select a portion of the pseudorandom sequence stored in the memory;
logic, coupled to the memory, configured to combine the selected portion of the pseudorandom sequence with a corresponding portion of an input data stream to produce a scrambled data word; and
a second register configured to store the scrambled data word.

13. The arrangement of claim 12, wherein the logic configured to generate a maximal length pseudorandom sequence of digital signals includes a linear feedback shift register.

14. The arrangement of claim 12, wherein the logic configured to combine the selected portion of the pseudorandom sequence with a corresponding portion of an input data stream includes a number of exclusive-OR logic gates, each exclusive-OR logic gate having:
a first input coupled to the memory for receiving a bit of the selected portion of the pseudorandom sequence;
a second input for receiving a bit of the corresponding portion of an input data stream; and
an output coupled to the second register.

15. The arrangement of claim 12, wherein the number of bits forming the selected portion of the pseudorandom sequence used to produce the scrambled data word is greater than one and is less than a number of bits forming the entire pseudorandom sequence.

16. The arrangement of claim 12, wherein the logic configured to select a portion of the pseudorandom sequence and the second register are configured to receive a clock signal operating at a rate equal to a data rate of the input data stream divided by the number of bits forming the selected portion of the pseudorandom sequence used to produce the scrambled data word.

17. The arrangement of claim 16, wherein a portion of the pseudorandom sequence stored in the memory is selected on a transition of the clock signal at substantially a same time that the scrambled data word is transferred out of the second register.

18. The arrangement of claim 12, comprising:
logic configured to bypass the combining of the selected portion of the pseudorandom sequence with a corresponding portion of an input data stream.

19. The arrangement of claim 18, wherein the logic configured to bypass the combining of the selected portion of the pseudorandom sequence with a corresponding portion of an input data stream includes a number of AND logic gates, each AND logic gate having:
a first input coupled to the memory for receiving a bit of the selected portion of the pseudorandom sequence;
a second input for receiving a common bypass control signal; and
an output coupled to the logic configured to combine the selected portion of the pseudorandom sequence with a corresponding portion of an input data stream.

20. The arrangement of a claim 12, comprising:
a third register configured to store the corresponding portion of the input data stream used to produce the scrambled data word.

21. The arrangement of claim 12, wherein the logic configured to select a portion of the pseudorandom sequence stored in the memory comprises:
a state-machine configured to select the portion based on at least a prior-selected portion, the number of bits forming the entire pseudorandom sequence, and the number of bits forming the stored portions of the pseudorandom sequence
